(19) United States
(12) Patent Application Publication
(10) Pub. No.: US 2024/0083026 A1
(43) Pub. Date: Mar. 14, 2024

(54) ROBOT DEVICE

(71) Applicant: TECHMAGIC INC., Tokyo (JP)

(72) Inventor: Toshiyuki TAKADA, Tokyo (JP)

(21) Appl. No.: 18/510,657

(22) Filed: Nov. 16, 2023

Related U.S. Application Data
(63) Continuation of application No. PCT/JP2022/010599, filed on Mar. 10, 2022.

(30) Foreign Application Priority Data
Aug. 31, 2021 (JP) 2021-140946

(51) Int. Cl. B25J 9/16

(52) U.S. Cl. CPC B25J 9/1651; B25J 9/1661; B25J 9/1687

(57) ABSTRACT

Provided is a conveyance robot device that can convey a to-be-conveyed object contained in a container at a high velocity without spilling the to-be-conveyed object. A robot device according to the present invention is a robot device including a robot configured to convey a to-be-conveyed object contained in a container and the container together, and a control device configured to control the robot. A posture of the container is controlled by the robot so as to correspond to the direction of a combined acceleration vector of robot acceleration applied to the to-be-conveyed object or the container by the robot and gravitational acceleration acting on the to-be-conveyed object. The robot is controlled so that an upper limit for a robot jerk, which is a rate of change of the robot acceleration, is limited to a predetermined value.

### RELATED APPLICATIONS

The present application is a continuation application of International Application No. PCT/JP2022/010599 filed Mar. 10, 2022, which claims priority to Japanese Application No. 2021-140946, filed Aug. 31, 2021, the disclosures of which applications are hereby incorporated by reference herein in their entirety.

### TECHNICAL FIELD

The present invention relates to a robot device.

### BACKGROUND ART

In recent years, given the situation with a lack of employees in eating and drinking establishments, there has been a demand for automation of service processes in eating and drinking establishments. In automating beverage serving, a beverage contained in a container is required to be conveyed without spilling.

PTL 1 describes a robot device in which, to prevent a to-be-conveyed object contained in a container from spilling, an inertial acceleration vector and a gravitational acceleration vector are combined to derive a combined acceleration vector, and this robot device controls the robot posture according to the derived combined acceleration vector.

### CITATION LIST

### Patent Literature

PTL 1: Japanese Patent Application Laid-Open No. 2005-001055

### SUMMARY OF INVENTION

### Technical Problem

PTL 1 describes that the robot posture is controlled according to the combined acceleration vector to prevent the to-be-conveyed object contained in the container from spilling. However, for example, when a liquid object is conveyed, the surface of the liquid object is undulated, and when the liquid object is moved at a high velocity, a problem that the liquid object spills out of the container occurs. In the robot device in PTL 1, the only way to prevent the liquid object from spilling is to drive the robot device at a low velocity, but in this case, a problem that high velocity conveyance cannot be achieved occurs. An object of the present invention is to provide a robot device that can convey a to-be-conveyed object contained in a container at a high velocity without spilling the to-be-conveyed object.

### Solution to Problem

The above-described object of the present invention can be achieved by the following configuration. That is, a robot device according to a first aspect of the present invention is a robot device including a robot configured to convey a to-be-conveyed object contained in a container and the container together, and a control device configured to control the robot. In the robot device, the posture of the container is controlled by the robot so as to correspond to a direction of a combined acceleration vector of robot acceleration, which is applied to the to-be-conveyed object or the container by the robot, and gravitational acceleration acting on the to-be-conveyed object. The robot is controlled so that an upper limit for a robot jerk, which is a rate of change of the robot acceleration, is limited to a predetermined value.

### Advantageous Effects of Invention

With the robot device according to the first aspect of the present invention, since the posture of the container is controlled so as to correspond to the direction of the combined acceleration vector acting on the to-be-conveyed object, the to-be-conveyed object is prevented from spilling out of the container. Moreover, by limiting the upper limit for the robot jerk, which is the rate of change of the robot acceleration, to the predetermined value, the state of the to-be-conveyed object becomes stable. For example, in a case where the to-be-conveyed object is a liquid object, undulation can be suppressed. Therefore, it is possible to provide a conveyance robot device that can convey a to-be-conveyed object contained in a container at a high velocity without spilling the to-be-conveyed object.

### BRIEF DESCRIPTION OF DRAWINGS

FIG. 1 is an explanatory diagram of an automatic beverage serving system using a robot device according to a first embodiment of the present invention.

FIG. 2 is a schematic block diagram of the automatic beverage serving system according to the first embodiment of the present invention.

FIG. 3 is an explanatory diagram of a hand unit of the robot device according to the first embodiment of the present invention.

FIG. 4 is an explanatory diagram of trajectory control for the robot arm according to the first embodiment of the present invention.

FIG. 5 is an explanatory diagram of posture control of a container according to the first embodiment of the present invention.

FIG. 6 is an explanatory diagram of jerk control of the robot arm according to the first embodiment of the present invention.

### DESCRIPTION OF EMBODIMENTS

Hereinbelow, a robot device according to an embodiment of the present invention will be described with reference to the drawings. Note that the embodiment described below illustrates a robot device for embodying a technical idea of the present invention and is not intended to limit the present invention to the embodied device, and the present invention can also equally be applied to other embodiments encompassed by the scope of the claims.

### First Embodiment

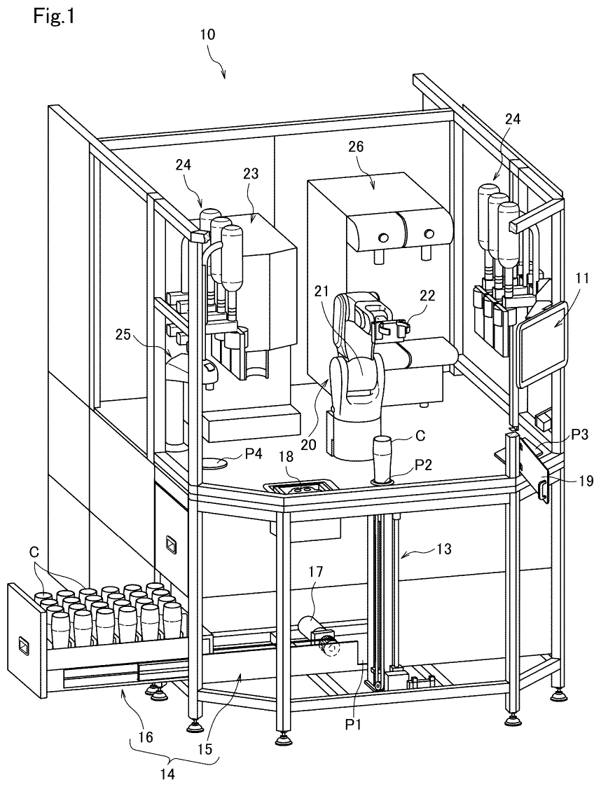

A robot device 20 according to a first embodiment of the present invention will be described with reference to FIGS. 1 to 4. FIG. 1 is an explanatory diagram of an automatic beverage serving system 10 using the robot device 20 according to the first embodiment of the present invention.

<Regarding Automatic Beverage Serving System 10>

The automatic beverage serving system 10 includes an order input device 11 that receives an order of a beverage, and beverage supply devices that each supply a beverage including a beer server 26, a carbonated water server 25, an ice dispenser 23, a one-shot measure 24, a water server (not illustrated), and the like. The automatic beverage serving system 10 also includes a container storage unit 14 that stores containers C, a container supply device 13 that conveys the container C stored in the container storage unit 14 from a feeding position P1 to a supply position P2, and a chiller 18 that cools the container.

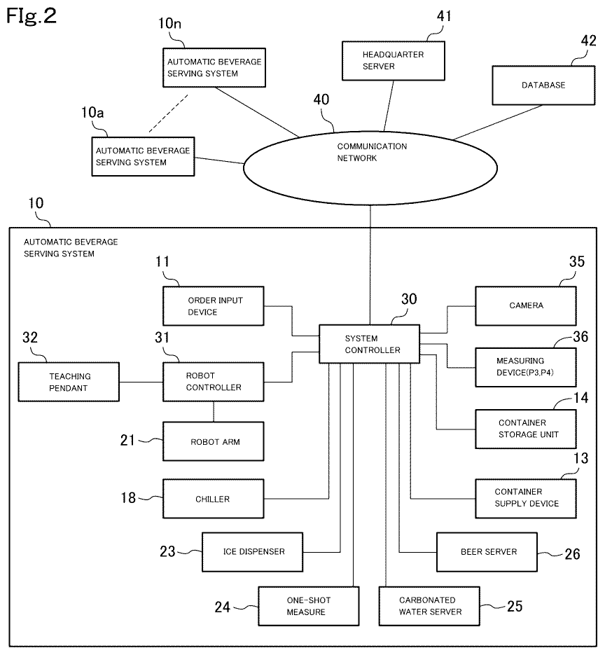

The robot device 20 includes a robot controller 31 (refer to FIG. 2) and a robot arm 21. The robot arm 21 is not particularly limited and is an articulated robot arm such as a six-axis robot arm. The robot arm 21 includes a hand unit 22 that holds the container C. This hand unit 22 holds the container C and conveys the container C across the supply position P2, a pouring position P4, pouring positions of the respective beverage supply devices, and a serving position P3.

The container storage unit 14 is built at the lower portion of the automatic beverage serving system 10. The container storage unit 14 is provided with a storage unit main body 15, a drawer unit 16 that is slidably attached to the storage unit main body 15 and houses a plurality of containers C, and a storage unit driving device 17 that drives the drawer unit 16. Driven by the storage unit driving device 17, the drawer unit 16 slides between a storage position and an outside drawn position. When the drawer unit 16 is at the storage position, one container C at a time is taken out from the feeding position P1 to the supply position P2 by the container supply device 13. Since the container storage unit 14 is configured to be at the lower portion of the automatic beverage serving system 10, the storage space for the containers C can be secured on the lower side of the robot arm 21, and in a case where a cooling device is provided in the container storage unit 14, cool air stays on the lower side, allowing for improvement of the cooling efficiency.

FIG. 2 is a schematic block diagram of the automatic beverage serving system of the first embodiment. The automatic beverage serving system 10 includes a system controller 30, the order input device 11, the robot controller 31, a camera 35, a measuring device 36, the container storage unit 14, the container supply device 13, the ice dispenser 23, the one-shot measure 24, the carbonated water server 25, the beer server 26, and the like.

The system controller 30 is connected to the order input device 11, the robot controller 31, the camera 35, the measuring device 36, the container storage unit 14, the container supply device 13, the ice dispenser 23, the one-shot measure 24, the carbonated water server 25, and the beer server 26 and controls the entire automatic beverage serving system 10.

The robot controller 31 controls the robot arm 21 on the basis of a control command from the system controller 30. Also, the robot controller 31 is connected to a teaching pendant 32 as well, and on the basis of an input from the teaching pendant 32, one can perform control setting independent of the control command from the system controller 30.

The order input device 11 includes, for example, a touch panel display. By receiving inputs interactively such as by providing a customer with a recommended menu and prompting the customer to provide input, the order input device 11 receives an order of a beverage. When the order of the beverage is received, the container C from the container storage unit 14 is fed from the feeding position P1 and is supplied to the supply position P2 by the container supply device 13. By using the hand unit 22, the robot arm 21 holds the container C, which has been supplied to the supply position P2. Furthermore, in a state where the container C is turned over with the opening thereof facing downward over the chiller 18, CO₂ is jetted into the container C by the robot arm 21, which operates the chiller 18, to cool the container C. Alternatively, CO₂ is jetted into the container C in response to a control command, from the system controller 30 to the chiller 18, that is sent according to the position of the robot arm 21. Note that in a case where a cooling device is provided in the container storage unit 14 and the container C is sufficiently cooled, or depending on the kind of beverage ordered, the cooling process provided by the chiller 18 may be omitted.

Subsequently, the robot arm 21 is controlled by the robot controller 31 on the basis of a control command from the system controller 30 and conveys the container C, in turn, to the pouring outlets of the beverage supply devices such as the ice dispenser 23, the one-shot measure 24, the carbonated water server 25, the water server (not illustrated), and the beer server 26 according to the order. Thus, the robot arm 21 automatically prepares the beverage as ordered by pouring each beverage in the container C in turn. To pour the beverage in the container C, the pouring operation of the beverage supply device may be controlled to be synchronized with the operation of the robot arm 21, or the hand unit 22 of the robot arm 21 may directly operate the operation lever or the like of the beverage supply device.

The amount of the beverage to be poured into the container from the beverage supply device is determined by the recipe corresponding to the order. For example, from the one-shot measure 24, a fixed amount of a beverage such as a whisky is supplied into the container C. From the ice dispenser 23, a fixed amount of ice corresponding to the order is poured into the container C. From the beer server 26, a fixed amount of beer corresponding to the order is poured into the container C, and the amount of foam is also set at a predetermined amount. From the carbonated water server 25, carbonated water in an amount determined by the recipe corresponding to the order is poured into the container C. From the water server, water in an amount determined by the recipe corresponding to the order is poured into the container C.

A measuring device is provided at the pouring position P4, which is a position where carbonated water or water is poured into the container C from the carbonated water server 25 or the water server or the like. This measuring device can measure, for example, the weight of carbonated water or water to be poured. Therefore, it is possible to confirm if a certain amount of a beverage as determined in the recipe corresponding to the order has been poured into the container C. Note that the amount of the beverage in the container C confirmed at this time is also used for posture control of the container C at the time of conveyance described below. In addition, a measuring device that measures, for example, the weight of the container C, is also provided at the serving position P3. Thus, the measuring device determines whether a certain amount of a beverage as ordered has been prepared. In a case where the predetermined amount of the beverage is contained in the container C, an electromagnetic lock of a serving area 19 is released to open the serving area 19, so that the beverage is served to the customer. Conversely, in a case where the amount of the beverage poured into the container C is different from the predetermined amount, the container C is not served to the customer but is conveyed to an appropriate collection unit (not illustrated) by the robot arm 21 and collected.

The system controller 30 can, in addition, communicate with a headquarter server 41, a database 42, other automatic beverage serving systems 10a to 10n, and the like via a communication network 40. The headquarter server 41 can collect information from the automatic beverage serving systems 10 and 10a to 10n of the respective stores. Furthermore, the headquarter server 41 can analyze information about recommended menus, recommended recipes, and the like of respective stores by methods such as machine learning, using big data such as information from the database 42. As a result, the headquarter server 41 can provide the respective stores with trained data obtained as a result of the analysis. The automatic beverage serving systems 10a to 10n of the respective stores can cooperate with one another to share customer information and consider menus by mutual communication. In this case, it is possible to construct a distributed information analysis system without depending only on information from the headquarter server 41.

<Regarding Hand Unit 22 of Robot Device>

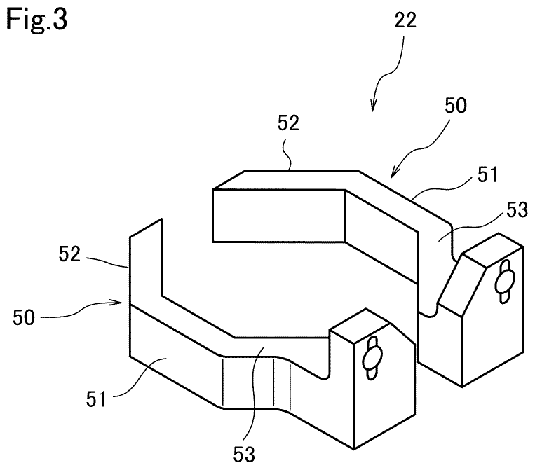

FIG. 3 is an explanatory diagram of the hand unit 22 of the robot device of the present embodiment. The robot arm 21 is provided with the hand unit 22 for holding the container C. The hand unit 22 can hold containers C with a plurality of specifications.

In the present embodiment, the hand unit 22 includes a pair of holding pieces 50 opposed to each other in the gripping direction. In each of the holding pieces 50, end piece portions 52 and 53 at two opposite ends are connected in a downward slope form to a linear middle piece portion 51 at the middle part. Since such a hand unit 22 comes into contact with the container C at a plurality of contact positions also in a case of holding a container C with a different outside diameter, the hand unit 22 can reliably hold containers C with different specifications. The hand unit 22 is set so that the end piece portions 52 and 53 hold the container C. Accordingly, even in a case where the container C has a different size, the container C can reliably be held as the container C is in contact with the hand unit 22 not only at the inner sides of the end piece portions 52 and 53 of one of the holding pieces 50 but also at the inner sides of the end piece portions 52 and 53 of the other holding piece 50. As a result, the outer periphery of the container C is in contact with the hand unit 22 at four positions in total. Note that the hand unit 22 can hold the container C softly by provision of a cushion material such as a urethane sponge on the surface thereof on the side gripping the container C.

<Trajectory Control for Robot Arm 21>

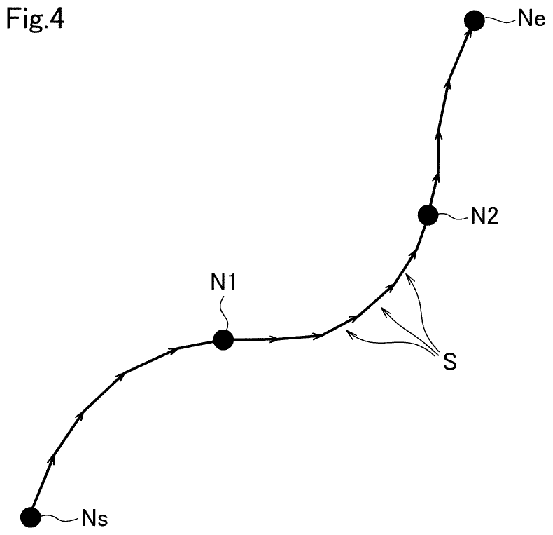

FIG. 4 is an explanatory diagram of trajectory control for the robot arm 21 of the present embodiment. The robot arm 21 holds and picks up from the supply position P2 the container C, which has been supplied, with use of the hand unit 22 so that the container C has a posture in which the opening of the container C faces upward. Then, the robot arm 21 moves the container C to a position above the chiller 18 and turns the container C so that the container C has a posture in which the opening thereof faces downward. After that, the container C is cooled by cooling-purpose CO₂ that is jetted from the chiller 18 by the operation of the chiller 18 or in response to a control command, from the system controller 30 to the chiller 18, that is sent according to the position of the robot arm 21.

The container C cooled by the chiller 18 is turned again by the robot arm 21 to have a posture in which the opening thereof faces upward and is then conveyed in turn to the pouring outlets of the beverage supply devices such as the ice dispenser 23, the one-shot measure 24, the carbonated water server 25, the water server (not illustrated), and the beer server 26 according to the order as needed. When a predetermined amount of the beverage as ordered is poured in the container C, the robot arm 21 conveys the container C from the pouring position to a position where the container C is put in the serving position P3. In a case where, after the container C is conveyed to the serving position P3, it is confirmed by the measuring device that the certain amount of the beverage as ordered is prepared, the electromagnetic lock of the serving area 19 is released to open the serving area 19, so that the beverage is served to the customer.

As for the position where carbonated water or water is poured into the container C from the carbonated water server 25 or the water server or the like, the container C is conveyed by the robot arm 21 so as to be put in the pouring position P4. The measuring device is provided at the pouring position P4, and can measure, for example, the weight of carbonated water or water poured. Therefore, it is possible to confirm if a certain amount of the beverage as determined in the recipe corresponding to the order has been poured into the container C. Note that the amount of the beverage in the container C confirmed at this time is also used for posture control of the container C at the time of conveyance described below.

For example, a case where beer is ordered will be described. The robot arm 21 holds and picks up from the supply position P2 the container C, which has been supplied, with use of the hand unit 22 so that the container C has a posture in which the opening of the container C faces upward. Then, the robot arm 21 moves the container C to a position above the chiller 18 and turns the container C so that the container C has a posture in which the opening thereof faces downward. After that, the container C is cooled by cooling-purpose CO₂ that is jetted from the chiller 18 by the operation of the chiller 18 or in response to a control command, from the system controller 30 to the chiller 18, that is sent according to the position of the robot arm 21 (process a1).

The container C cooled by the chiller 18 is turned again by the robot arm 21 to have a posture in which the opening thereof faces upward and is then conveyed to a position where the container C is put in the pouring position corresponding to the pouring outlet of the beer server 26 serving as the beverage supply device (process a2). Subsequently, the robot arm 21 once releases the container C, and the robot arm 21 operates the operation button of the beer server 26 or a control command is issued from the system controller 30 to the beer server 26a, so that a predetermined amount of beer as ordered is poured into the container C in a state where a predetermined amount of foam is made. Note that the beer server 26 is operated to automatically adjust the inclination of the container C in order to adjust the amount of foam to a predetermined amount. For this reason, the robot arm 21 once releases holding of the container C after putting the container C in the pouring position of the beer server 26. Note that, depending on the type of the beer server 26, beer may be poured into the container C from the beer server 26 with the robot arm 21 holding the container C.

The state where a predetermined amount of beer has been poured into the container C by the beer server 26 is confirmed on the basis of a notification signal from the beer server 26 to the system controller 30 or on the basis of a count that is kept by a timekeeping unit and is equivalent to beer pouring time. In a case where it is confirmed that the predetermined amount of beer has been poured into the container C, the robot arm 21 holds with the hand unit 22 the container C located at the pouring position of the beer server 26 and conveys the container C to a position where the container C is put in the serving position P3 (process a3).

Next, a case where a highball containing a single serving of whisky and carbonated water is ordered will be described. The robot arm 21 holds and picks up from the supply position P2 the container C, which has been supplied, with use of the hand unit 22 so that the container C has a posture in which the opening of the container C faces upward. Then, while keeping this posture, the robot arm 21 conveys the container C to a position to press an ice pouring lever corresponding to the ice pouring outlet of the ice dispenser 23 (process b1). By the operation of pressing the ice pouring lever with the container C, a predetermined amount of ice is put into the container C from the ice dispenser 23. The state where the predetermined amount of ice has been put into the container C from the ice dispenser 23 is confirmed on the basis of a notification signal from the ice dispenser 23 to the system controller 30 or on the basis of a count that is kept by a timekeeping unit and is equivalent to ice pouring time.

In a case where it is confirmed that the predetermined amount of ice has been put into the container C from the ice dispenser 23, the robot arm 21 conveys the container C from the position corresponding to the ice pouring outlet of the ice dispenser 23 to a position of the operation lever of the one-shot measure 24 corresponding to the beverage supply position of the one-shot measure 24 for the ordered whisky (process b2). As the robot arm 21 presses the operation lever of the one-shot measure 24 with the container C in this position, one finger of (the amount corresponding to a single serving) whisky is poured into the container C. The state where the amount of whisky as ordered has been poured into the container C from the one-shot measure 24 is confirmed, for example, on the basis of a count that is kept by a timekeeping unit and is equivalent to whisky pouring time.

In a case where it is confirmed that the amount of whisky as ordered has been poured into the container C from the one-shot measure 24, the robot arm 21 conveys the container C from the pouring position of the one-shot measure 24 to a position where the container C is put in the pouring position P4 of the carbonated water server 25 (process b3). A certain amount of carbonated water as ordered is poured into the container C by the robot arm 21 operating the operation lever of the carbonated water server 25 or in response to an operation command transmitted from the system controller 30 to the carbonated water server 25. Since the measuring device is provided at the pouring position P4, the measuring device can measure the amount of carbonated water that has been poured into the container C, for example, on the basis of the change in the total weight of the container C. When the amount of carbonated water that has been poured into the container C reaches a predetermined amount as ordered, pouring of carbonated water is stopped. The state where the amount of carbonated water that has been poured into the container C reaches the predetermined amount as ordered is detected by the measuring device provided at the pouring position P4. Note that, in a case where the carbonated water server is set in advance to pour the predetermined amount of carbonated water into the container C, measurement by means of the measuring device is not required. The state where the amount of carbonated water that has been poured into the container C reaches the predetermined amount as ordered is detected by the measuring device or is confirmed on the basis of a count that is kept by a timekeeping unit and is equivalent to carbonated water pouring time.

In a case where it is confirmed that the amount of carbonated water that has been poured into the container C reaches the predetermined amount as ordered, the robot arm 21 holds the container C with the hand unit 22 and conveys the container C from the pouring position P4 of the carbonated water server to a position where the container C is put in the serving position P3 (process b4).

The trajectory followed when the robot arm 21 holds and conveys the container C with the hand unit 22 is set by specifying a start node Ns and an end node Ne from the system controller 30 to the robot controller 31. FIG. 4 is an explanatory diagram of trajectory control for the robot arm 21 of the present embodiment.

The start node Ns and the end node Ne are set as two points in a reachable work area for the robot arm 21 in a three-dimensional space which is an installing space for the robot arm 21 of the automatic beverage serving system 10. After the start node Ns and the end node Ne are set, the robot controller 31 determines the number of middle nodes in a range of 0 to a predetermined number n (n is an integer). In a process in which the moving distance of the robot arm 21 is short, the number of the middle nodes may be 0. For example, in the processes a2, a3, b1, and b4, two middle nodes, which are middle nodes N1 and N2, are automatically set so that the trajectory may avoid obstacles, and so that the robot arm 21 may be prevented from having a peculiar posture although it is not particularly limited in the present embodiment. Also, in determining the trajectory, attention is paid to prevent the trajectory from becoming a curve with abrupt turns. This is also effective to prevent the acceleration (the acceleration corresponds to the robot acceleration, and is hereinbelow referred to as “acceleration”) from being rapidly changed. However, the robot controller 31 can set a curve with abrupt turns as the trajectory. Hence, in a case where the trajectory is a curve with abrupt turns, the acceleration of the robot arm is configured to be lowered according to the curvature of the trajectory.

In a case where the container C is put in the end position in a state of bringing the bottom surface of the container C into contact with the floor surface in the container putting position, the end node Ne is set so that the bottom surface of the container C is located at a position higher by a predetermined height h than the contact position with the floor surface. The height h is set to, for example, about 0.05 mm to 10 mm, and preferably about 0.1 to 0.5 mm, although it is not particularly limited. After reaching the end node Ne, which is a position higher by the height h than the target position, the robot arm 21 moves the container C held with the hand unit 22 downward by the height h at a predetermined velocity and puts the container C on the floor surface, which is the target position, to convey the container C to the target position.

After the middle nodes N1 and N2 are automatically set, the trajectory of the hand unit 22 of the robot arm 21 from the start node Ns via the middle node N1 and the middle node N2 in this order to the end node Ne is calculated in the robot controller 31. The reference point in calculating the trajectory of the tip end of the hand unit 22 is a center position through which the axis of the container C passes in a range in the height direction of the container C the outer periphery of which is in contact with the hand unit 22 at four positions in total, although it is not particularly limited in the present embodiment. Here the four positions include the portions at which the inner sides of the end piece portions 52 and 53 of one holding piece 50 are in contact with the container C and the portions at which the inner sides of the end piece portions 52 and 53 of the other holding piece 50 are in contact with the container C when the hand unit 22 holds the container C. Since the container C is taken out in response to the order and the dimension of the container C is known at the time of the order, the three-dimensional coordinates at the tip end of the hand unit 22 of the robot arm 21 corresponding to the beverage supply position in each beverage supply device can be calculated.

The robot controller 31 optimizes the trajectory plan of the hand unit 22. For calculation of the trajectory of the hand unit 22, a method based on random sampling such as PRM (Probabilistic Roadmap Method) and RRT (Rapidly-Exploring Random Tree) can be employed. Also, a method of connecting the nodes to each other using a spline function can be employed, and for example, interpolation can be conducted using a B-spline function to make a line between nodes smooth. Various trajectory plans can be employed, and in the present embodiment, a method of conducting interpolation by interpolating a sequence of small straight lines between nodes (for the method, refer to FIG. 4) is employed, although it is not particularly limited.

The length of each step is set to about 0.5 mm to 2.0 mm, for example, 1.0 mm. The moving time between the steps is set to about 5 msec to 50 msec. By adjusting arrangement and an inter-step distance of steps S for interpolating the small straight lines, the degree of curving of the trajectory on which the interpolation has been conducted can be adjusted. The trajectory set in this manner is set not to draw a curve with abrupt turns. Although an example in which the lengths of the respective steps S are equal to one another is described in FIG. 4, the present embodiment is not limited to this, and the lengths of the steps S can be set to be different from one another. For example, the step S can be longer at a portion where the radius of the curve is shorter while the step S can be shorter at a portion where the radius of the curve is longer.

As a result, since a change of acceleration occurring between the adjacent small steps becomes slight, smooth control of the robot arm 21 can be achieved, which is advantageous in posture control and jerk control of the container C described below. In this manner, the trajectory of the hand unit 22 of the robot arm 21 from the start node Ns via the middle node N1 and the middle node N2 in this order to the end node Ne is calculated to be a smooth trajectory, for example, as in the case of the spline interpolation. Moreover, since each step S is a straight line, calculation of velocity, acceleration, a jerk, and the like is simple.

<Regarding Posture Control of Container C>

In the automatic beverage serving system 10, the container C in which a beverage is contained is required to be moved at a high velocity to serve the beverage rapidly. To do so, positive or negative acceleration is applied to the container C. In a case where the container C is empty, a case where the container C is supplied with only ice, or a case where the container C is supplied with a small amount of a beverage, such as a case where the container containing ice is supplied with a single serving of whisky, the beverage will not spill out of the container C even when the container C is accelerated or decelerated to move the container C at a high velocity.

On the other hand, consider a case where the container C is supplied with a large amount of a beverage, that is, a case where the container C is supplied with a predetermined amount or more of a beverage, such as a case where beer is poured into the container C until the beer including foam fills the container C to the top and a case where the container C is supplied with carbonated water in the amount to be served. In such a case, the beverage may spill out of the container C if acceleration is generated when the container C is held by the hand unit 22 of the robot arm 21 and is conveyed. Thus, in a case where the container C is supplied with a large amount of a beverage, the robot controller 31 controls the posture of the container C so that the posture of the container C is inclined depending on the acceleration applied to the container C. However, such posture control of the container C is not executed in a case where there is no possibility that the beverage will spill out of the container C as in a case where the container C is supplied with a small amount of the beverage.

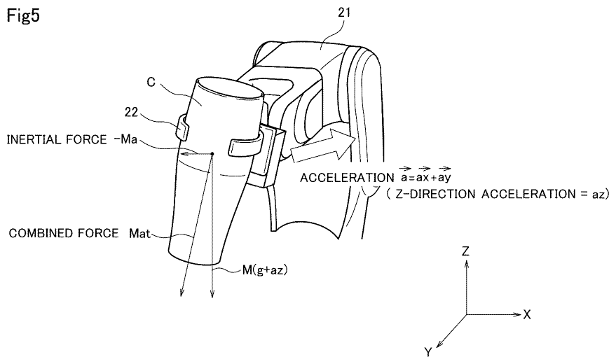

FIG. 5 is an explanatory diagram of posture control of the container C according to the present embodiment. In a case where the robot arm 21 holds the container C with the hand unit 22 and conveys the container C, acceleration in the positive direction of the traveling direction is applied to the container C at the time of velocity increase from the start node Ns, and acceleration in the negative direction of the traveling direction is applied to the container C at the time of velocity decrease to the end node Ne. When an acceleration vector a (a combined vector of an X-axial direction acceleration vector ax and a Y-axial direction acceleration vector ay) is applied to the container C in the X-Y direction, and acceleration az is applied to the container C in the Z direction, an inertial force in the reverse direction of the traveling direction, in addition to a gravitational force, acts on the beverage contained in the container C. Thus, a combined force Mat composed of an inertial force −Ma in the X-Y direction and a force M (g+az) acting in the z direction acts on the container C. Hence, by inclining the container C according to the direction of the combined force Mat, the beverage can be prevented from spilling out of the container C.

The angle at which the container C is inclined when the container C supplied with a predetermined amount or more of the beverage is conveyed is derived by the following equations according to the acceleration and the gravitational acceleration applied to the container C.

x-direction inclination=arctan(ax/(g+az)) Equation (1)

y-direction inclination=arctan(ay/(g+az)) Equation (2)

The center when the container C is inclined is the center of gravity of the beverage contained in the container C. Therefore, the center when the container C is inclined varies according to the amount of the beverage poured. In a case where beer is poured into the container C, the weight of the foam part on the upper side is lighter than the weight of the liquid part of the beer, and the weight of the foam part is thus calculated using a separate specific gravity. More specifically, the specific gravity values of the substances contained in the beverage in the container C can be taken into consideration, such as the specific gravity of the alcohol, the specific gravity of the carbonated water, and the specific gravity of the water. Also, correction can be done according to the amount of the ice. By aligning the center of gravity of the beverage contained in the container C with the center of the inclined container C, the posture control of the container C can be performed with a more precise consideration of the accelerational influence.

<Regarding Jerk Control>

As described above, in a case where the robot arm 21 conveys the container C containing a beverage while holding the container C with the hand unit 22, the posture of the container is controlled in consideration of acceleration applied to the container C by the robot arm 21. This posture control allows for the angle of the liquid surface of the beverage to be kept perpendicular to the axis of the container C. However, in order for the robot arm 21 to convey the container containing an ordered amount of a beverage at a high velocity without spilling the beverage, the undulation of the liquid surface in the container C is required to be suppressed. The reason for this is that, when the liquid surface in the container C undulates, the acceleration to be applied to the container C will need to be lowered, or the conveyance velocity will need to be lowered. To suppress the undulation of the liquid surface in the container C, a jerk (the jerk means the rate of change of acceleration over time, corresponds to a robot jerk, and is hereinbelow referred to as a “jerk”), which is the first derivative of the acceleration applied to the container C, needs to be taken into consideration. That is, the jerk needs to be limited to a predetermined value or less.

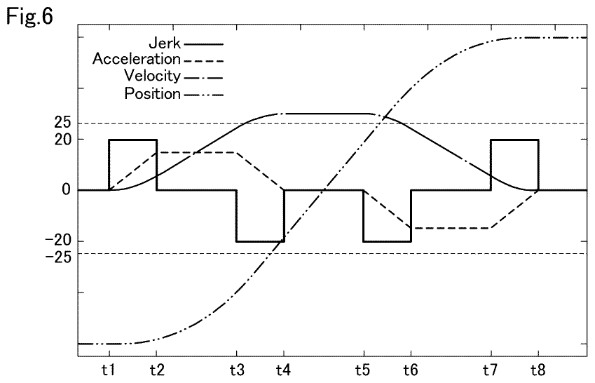

FIG. 6 is an explanatory diagram of jerk control of the robot arm 21 according to the present embodiment. In general, in controlling a robot arm, the acceleration tends to change significantly, and in this case, the value of the jerk often reaches a high value as a pulse. In the case where the value of the jerk of the robot arm 21 is high, a large undulation will be generated on the liquid surface of the beverage contained in the container C held by the hand unit 22.

In the present embodiment, to allow for the container C, in a state where a predetermined amount of the beverage as ordered is contained, to be conveyed at a high velocity without spilling the beverage, jerk control, as well as the aforementioned posture control of the container C according to acceleration, is used. In FIG. 6, the solid line represents a jerk of the tip end of the hand unit 22 of the robot arm 21, the dashed line represents acceleration of the tip end of the hand unit 22 of the robot arm 21, the dashed-dotted line represents velocity of the tip end of the hand unit 22 of the robot arm 21, and the dashed-two dotted line represents a position of the tip end of the hand unit 22 of the robot arm 21. Here, the jerk is the first derivative of the acceleration, the acceleration is the first derivative of the velocity, and the velocity is the first derivative of the position.

In FIG. 6, control is performed so that the jerk of the tip end of the hand unit 22 of the robot arm 21 is kept constant at 20 m/s³. At the start node Ns, velocity increase of the robot arm 21 is started (time t1), and the jerk is kept constant at 20 m/s³ (time t1 to time t2). The upper limit value for the acceleration is defined according to the specifications of the robot arm 21. Thus, when the acceleration increases to reach a predetermined value while the jerk is constant, the jerk becomes 0 m/s³ (time t2). Thereafter, the velocity is increased while the acceleration is constant (time t2 to time t3). The jerk is 0 m/s³ while the acceleration is constant. Also, the velocity linearly increases while the acceleration is constant.

The upper limit value for the velocity is defined according to the specifications of the robot arm 21. Thus, when the velocity increases to reach a predetermined value while the acceleration is constant, the acceleration starts to decrease (time t3). At time t3, the jerk is −20 m/s³ and is kept constant (time t3 to time t4). When the acceleration becomes 0 m/s², the jerk becomes 0 m/s³ (time t4). Since the acceleration is 0 m/s² during the period from time t4 to time t5, the velocity is kept at a constant value below an operational velocity limit for the robot arm 21.

When the tip end of the hand unit 22 of the robot arm 21 gets close to the end node Ne, velocity decrease is started (time t5). During the period from time t5 to time t6, the jerk is −20 m/s³ and is kept constant, and the acceleration changes in the negative direction (time t5 to time t6). The upper limit magnitude for the negative acceleration is also defined according to the specifications of the robot arm 21. Thus, when the acceleration changes in the negative direction and decreases to reach a predetermined value while the jerk is constant, the jerk is 0 m/s³ (time t6). Thereafter, the acceleration is kept at a negative constant value. During this period, the jerk is 0 m/s³, and the velocity linearly decreases (time t6 to time t7). When the velocity approaches 0 m/s, the jerk is kept constant at 20 m/s³ (time t7 to time t8). During the period from time t7 to time t8, the acceleration linearly changes from the predetermined negative value to 0 m/s², and the velocity is decreased. At time t8, when the tip end reaches the end node Ne, the velocity becomes 0 m/s. At time t8, the jerk is also 0 m/s³, and the acceleration is also 0 m/s².

In this manner, since the jerk is kept at a constant value to cause the acceleration to moderately change, the robot arm 21 can convey the container C, in a state of containing a predetermined amount of the beverage as ordered, held with the hand unit 22 at a high velocity without spilling the beverage.

<Regarding Limitation of Jerk>

In the present embodiment, the jerk control and the posture control of the container C are used in combination. In this case, the jerk control of the tip end of the hand unit 22 of the robot arm 21 has limitations according to the specifications of the robot arm 21. During the period from time t1 to time t2, the jerk is constant at 20 m/s³, and the acceleration linearly increases. During the period from time t1 to time t2, the posture control of the container C is performed along with the increase of the acceleration, that is, the posture of the container C is controlled on the basis of Equations (1) and (2) described above to conform to the increase of the acceleration. Since the posture change of the robot arm 21 due to the posture control of the container C is required to follow the increase of the acceleration, the change of the acceleration, that is, the jerk, has limitations. In addition, as described above, since the acceleration of the robot arm 21 has an upper limit value according to the specifications, the value of the jerk also has limitations.

During the period from time t3 to time t4, the jerk is constant at −20 m/s³, and the acceleration linearly decreases. During the period from time t3 to time t4, the posture control of the container C is performed along with the decrease of the acceleration, that is, the posture of the container C is controlled to conform to the decrease of the acceleration. Since the posture change of the robot arm 21 due to the posture control of the container C is required to follow the decrease of the acceleration, the change of the acceleration, that is, the jerk, has limitations.

Similarly to the above, as for the jerk control and the change of the acceleration during the period from time t5 to time t6 and the period from time t7 to time t8, since the posture change of the robot arm 21 due to the posture control of the container C is required to follow the change of the acceleration, the change of the acceleration, that is, the jerk, has limitations. This means that the instructed value for the acceleration has an influence on the upper limit value for the jerk. Also, as described above, since the upper limit value for the velocity is defined according to the specifications of the robot arm 21, the acceleration also has limitations. This means that the instructed value for the velocity also has an influence on the upper limit value for the jerk.

In the example in FIG. 6, the jerk is constant at 20 m/s³, and an upper limit value for the jerk is set according to the specifications of the robot arm 21. In the example in FIG. 6, the robot arm 21 in which the upper limit for the jerk is 25 m/s³ has been illustrated although it is not particularly limited. Although the upper limit value for the jerk is set according to the specifications of the robot arm 21 and is not particularly limited, a predetermined value for the upper limit for the jerk can be, for example, 10 to 200 m/s³.

In the example in FIG. 6, although the jerk is set to a constant value, the jerk can linearly increase or decrease as in the case of the change of the acceleration in FIG. 6 or smoothly increase or decrease. By changing the jerk smoothly, the upper limit value for a snap (the snap is also referred to as a jounce and means the rate of change of the jerk over time), which is the first derivative of the jerk, also has limitations. In a case where the jerk is changed smoothly in this manner, the change of the acceleration is not linear but becomes smoother.

The present embodiment employs a method of conducting interpolation by interpolating a sequence of small straight lines between nodes. Also, the trajectory including the small steps is set not to draw a curve with abrupt turns. Accordingly, since the change of the acceleration occurring between the adjacent small steps is slight, smooth control of the robot arm 21 can be achieved. In the posture control and the jerk control of the container C, continuity is maintained. Therefore, even when the robot arm moves the container C at a high velocity, the robot arm can convey the container C without spilling the beverage contained in the container C. Since the route from the start node Ns via the middle node N1 and the middle node N2 in this order to the end node Ne is set in a three-dimensional space, the respective vectors of the jerk, the acceleration, and the velocity correspond to the three-dimensional trajectory, such as the trajectory including a sequence of the interpolated small straight lines. Note that, although the continuous acceleration and jerk control in the route from the start node Ns via the middle node N1 and the middle node N2 in this order to the end node Ne has been described here, the present embodiment is not limited to this. For example, acceleration and jerk control in which, in the acceleration change from the start node Ns to the end node Ne, the acceleration is once set to zero at the middle node N1 and the middle node N2, can be performed. Alternatively, in a case where the distance from the start node Ns to the end node Ne is short, either the middle node N1 or the middle node N2, or both, can be omitted.

The present embodiment described above illustrates a robot device for embodying a technical idea of the present invention and is not intended to limit the present invention to the embodied device, and the present invention can also equally be applied to other embodiments such as a modification of the present embodiment and a combination of the respective techniques described in the present embodiment. Also, although an example in which a beverage is contained in the container C has been described in the present embodiment, an object contained in the container C and conveyed by the robot arm 21 is not limited to a liquid object but includes various to-be-conveyed objects such as an amorphous object including powder, a granular object, and the like and an object to be conveyed without being dropped out of the container including a stick-shaped body.

1. A robot device comprising: a robot configured to convey a to-be-conveyed object contained in a container and the container together; and a control device configured to control the robot, wherein:
a posture of the container is controlled by the robot so as to correspond to a direction of a combined acceleration vector of robot acceleration, which is applied to the to-be-conveyed object or the container by the robot, and
gravitational acceleration acting on the to-be-conveyed object; and
the robot is controlled so that an upper limit for a robot jerk, which is a rate of change of the robot acceleration, is limited to a predetermined value.

2. The robot device according to claim 1, wherein an acceleration upper limit value is set for the robot acceleration, and when the robot acceleration is equal to or more than the acceleration upper limit value, the jerk is set to zero.

3. The robot device according to claim 1, wherein when the posture of the container is controlled by the robot so as to correspond to the direction of the combined acceleration vector, the posture is controlled with a center of gravity of the to-be-conveyed object contained in the container as a center.

4. The robot device according to claim 1, wherein the predetermined value to which the upper limit for the robot jerk is limited is set according to a response characteristic corresponding to at least either an instructed value for the robot acceleration or an instructed value for a velocity.

5. The robot device according to claim 4, wherein the predetermined value to which the upper limit for the robot jerk is limited is 10 to 200 m/s³.

6. A robot control method for controlling a robot configured to convey a to-be-conveyed object contained in a container and the container together, the robot control method comprising the steps of;
controlling a posture of the container by the robot so as to correspond to a direction of a combined acceleration vector of robot acceleration applied to the to-be-conveyed object or the container by the robot and gravitational acceleration acting on the to-be-conveyed object; and
controlling the robot so that an upper limit for a robot jerk, which is a rate of change of the robot acceleration, is limited to a predetermined value.

7. A program for causing a computer to execute respective steps of the robot control method according to claim 6.
